(19) United States
(12) Patent Application Publication
(10) Pub. No.: US 2025/0207728 A1
(43) Pub. Date: Jun. 26, 2025

(54) HYDROGEN TANK

(71) Applicant: TOYOTA JIDOSHA KABUSHIKI KAISHA, Toyota-shi Aichi-ken (JP)

(72) Inventor: Youjirou IRIYAMA, Toyota-shi Aichi-ken (JP)

(73) Assignee: TOYOTA JIDOSHA KABUSHIKI KAISHA, Toyota-shi Aichi-ken (JP)

(21) Appl. No.: 18/973,704

(22) Filed: Dec. 9, 2024

(30) Foreign Application Priority Data
Dec. 21, 2023 (JP) 2023-215422

(51) Int. Cl. F17C 1/16

(52) U.S. Cl. CPC F17C 1/16; F17C 2201/0109; F17C 2203/0604; F17C 2203/0619; F17C 2203/0673; F17C 2205/0323; F17C 2221/012

(57) ABSTRACT

In the liner constituting the hydrogen tank, it is intended to enable visual inspection of foreign matter contamination. A hydrogen tank comprising a liner, wherein the liner comprises a cylindrical portion and a dome portion disposed at each of both ends of the cylindrical portion, wherein the dome portion has a body and a joint portion joined to the cylindrical portion, and the joint portion of the dome portion has a portion with a deep color, and the body is more translucent than the joint portion.

### CROSS-REFERENCE TO RELATED APPLICATIONS

This application is based upon and claims the benefit of priority of the prior Japanese Patent Application No. 2023-215422, filed on Dec. 21, 2023, the entire contents of which are incorporated herein by reference.

### FIELD

The present disclosure relates to a hydrogen tank storing hydrogen.

### BACKGROUND

Patent Document 1 discloses that 3 components of a dome member, a torso, and a dome member are fused at 2 locations to produce a liner.

### CITATION LIST

### Patent Literature

Patent Literature 1: JP 2020-112256 A

### SUMMARY

### Technical Problem

Bonding of the dome member and the fuselage is conceivable to be performed by laser welding, the material constituting the dome member is to heat by absorbing the energy of the laser, it is necessary to black. However, by making it black, the identification inspection of the foreign matter contamination by the appearance becomes difficult.

In view of the above problems in the present disclosure, it is an object of the present disclosure to make it possible to visually inspect foreign matter contamination in a liner constituting a hydrogen tank.

### Solution to Problem

The present application discloses a hydrogen tank comprising a liner, wherein the liner comprises a cylindrical portion and a dome portion disposed at each of both ends of the cylindrical portion, wherein the dome portion has a body and a joint portion joined to the cylindrical portion, and the joint portion of the dome portion has a portion with a deep color, and the body is more translucent than the joint portion.

The joint portion, along its periphery, the thin film portion where the dark color is attached extends annularly, the thin film portion may be configured to be joined to the cylindrical portion in contact with the cylindrical portion.

The joint portion includes a first annular portion, provided on the cylindrical portion side than the first annular portion, and a second annular portion having an outer diameter smaller than the first annular portion, the first annular portion inclined portion whose diameter decreases toward the second annular portion is provided, the cylindrical portion and the dome portion may be configured to be joined at an inclined portion of at least the first annular portion.

### Effects

According to the present disclosure, since the body of the dome portion has higher translucency than the joint portion, it is possible to visually inspect foreign matters in the liner. On the other hand, since the dome portion and the cylindrical portion is joined at a joint portion having a portion which is dark, it is possible to obtain a sufficient bonding quality even if it is joined by laser welding.

### BRIEF DESCRIPTION OF DRAWINGS

FIG. 1 is an external view showing the configuration of the hydrogen tank 1.

FIG. 2 is a cross-sectional view showing the configuration of the hydrogen tank 1.

FIG. 3 is a cross-sectional view of liner 10.

FIG. 4 is an exploded cross-sectional view of liner 10.

FIG. 5 is a diagram illustrating the joining portion 14 of the form 1.

FIG. 6 is a diagram for explaining a modification of FIG.

FIG. 7 is a diagram illustrating a joint 24 of the form 2.

FIG. 8 is a diagram illustrating a modification of FIG.

FIG. 9 is a diagram illustrating a modification of FIG.

### DESCRIPTION OF EMBODIMENTS

### 1. Basic Structure of a Hydrogen Tank

The present disclosure features a liner contained in a hydrogen tank. Before describing the features of the liner, the basic structure of the hydrogen tank including the liner as one member will be described.

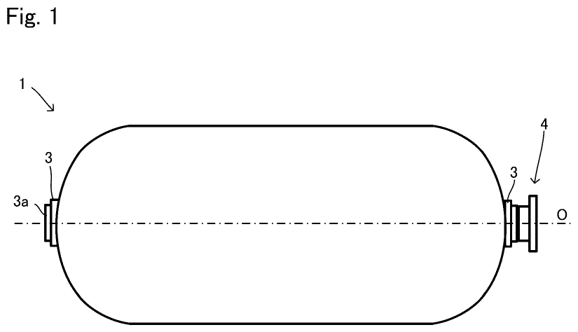

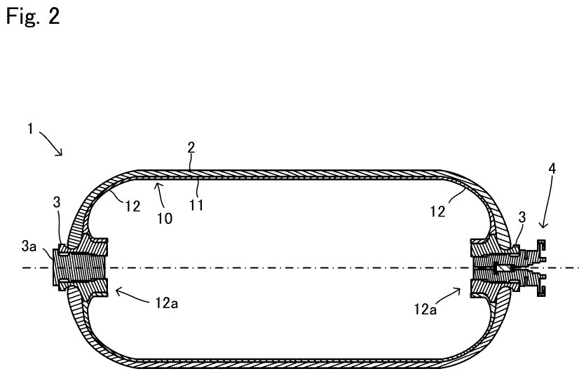

The hydrogen tank 1 is a container for storing hydrogen as a fuel in a liquid state or a gaseous state. FIG. 1 and FIG. 2 showed the figure for an explanation. FIG. 1 is an external view. FIG. 2 is a sectional view taken along the direction of the axis O of the hydrogen tank 1. As can be seen from these figures, the hydrogen tank 1 in the present embodiment has a liner 10, a reinforcing layer 2, a mouthpiece 3, and an on-off valve 4. Each configuration will be described below.

### 1.1. Liner

An overview of the liner 10 is shown here, and details will be described later.

The liner 10 is a hollow member which partitions the internal space of the hydrogen tank 1, and is cylindrical in this form. Liner 10 has a cylindrical portion 11 which is a cylindrical shape whose diameter is generally constant, a dome portion 12 which is a dome-shaped disposed so as to cover each of the openings at both ends of the cylindrical portion 11.

The opposite to the cylindrical portion 11 of the dome portion 12 is narrowed diameter by a dome-shaped, the mouthpiece 3 is disposed in an opening 12a formed in the narrowed end.

### 1.2. Reinforcement Layer

In the reinforcing layer 2, fibers are laminated over a plurality of layers, and a cured resin is impregnated into the fibers. A layer made of fibers is formed by winding a fiber bundle over a plurality of layers to a predetermined thickness on an outer periphery of a liner 10. Although the thickness of the reinforcing layer 2 and the number of turns of the fiber bundle are determined by the required strength, they are not particularly limited, but are of a 10 mm to 30 mm degree.

### Fiber Bundle

For example, carbon fibers are used for the fiber bundle of the reinforcing layer 13, and the fiber bundle has a band shape in which carbon fibers form a bundle and have a predetermined cross-sectional shape (e.g., a rectangular cross section) Although not particularly limited, there may be mentioned a rectangular shape having a 6 mm to 20 mm cross section and a 0.1 mm to 0.3 mm thickness. The amount of carbon fibers contained in the fiber bundle is not particularly limited, and examples thereof include a carbon fiber of about 36000

### Impregnated Resin

The resin impregnated and cured in the fiber (fiber bundle) in the reinforcing layer 2 is not particularly limited as long as it can increase the strength of the fiber by this. Examples thereof include a thermosetting resin which is cured by heat, and specific examples thereof include an amine-based or anhydride-based curing accelerator and an epoxy resin containing a rubber-based reinforcing agent, an unsaturated polyester resin, and the like. In addition, a resin composition containing an epoxy resin as a main agent and cured by mixing a curing agent thereto can be also mentioned. According to this, it is automatically cured by allowing the resin composition which is the mixture to reach and penetrate the fiber layer between the time when the main agent and the curing agent are mixed and cured.

### Protective Layer

If necessary, a protective layer may be disposed on an outer periphery of the reinforcing layer. When provided, for example, glass fibers are wound and impregnated with a resin. The resin to be impregnated can be considered similarly to the reinforcing layer 12. Thus, impact resistance can be imparted to the hydrogen tank 1.

Although there is no particular limitation on the thickness of the protective layer, it may be a 1.0 mm to 1.5 mm degree.

### 1.3. Mouthpiece

Mouthpiece 3 is a member which is attached to each of the two opening 12a of the liner 10 is disposed at each of the axial O-direction opposite ends of the liner 10. Mouthpiece 3 functions as an opening for communicating the inside and outside of the hydrogen tank 1, on one of which the on-off valve 4 is attached. Thus the mouthpiece 3, the cross section for the on-off valve 4 is arranged circular hole is provided. The inner surface of the hole is provided with a female screw corresponding to the male screw of the on-off valve 4. The on-off valve 4 is fixed to the mouthpiece 3 by combining with the male screw of the on-off valve 4 to the female screw. Further, the inner surface of the hole has a sealing surface which is a smooth surface on the tank inside (high pressure side) than the female thread. The seal member provided on the outer periphery of the on-off valve 4 on the seal surface is in contact with the inside of the hydrogen tank 1 airtight (seal) is made.

Although there is no particular limitation as long as the member constituting the mouthpiece 3 has the necessary strength, stainless steel, aluminum, and the like can be mentioned.

### 1.4. On-Off Valve

On-off valve 4 is held in the hole of the mouthpiece 3 so as to pass the inside and outside of the hydrogen tank 1. The on-off valve 4 is disposed on one of the two mouthpieces 3 provided at both longitudinal ends of the hydrogen tank 1. In addition, a plug 3a is disposed and sealed in the mouthpiece 3 on the other side.

The on-off valve 4 has a shaft portion disposed inside the hole of the mouthpiece 3 is provided with a male screw which is combined with the female screw of the mouthpiece 3 on the outer peripheral surface of the shaft portion, whereby the on-off valve 4 is fixed to the hole of the mouthpiece 3. Further, the outer peripheral surface of the on-off valve 4 is disposed a seal member (not shown), the seal member is disposed so as to contact the seal surface of the inner surface of the hole of the mouthpiece 3 airtight (seal) is made.

The on-off valve 4 is a valve for switching between the permission and the regulation of the extraction of hydrogen from the hydrogen tank 1.

A specific form of the on-off valve is not particularly limited, and a known on-off valve can be applied.

### 2. Liner

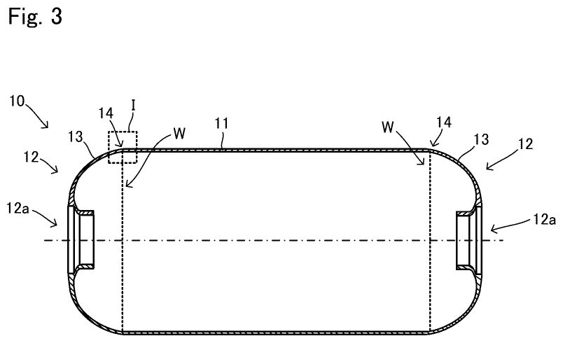

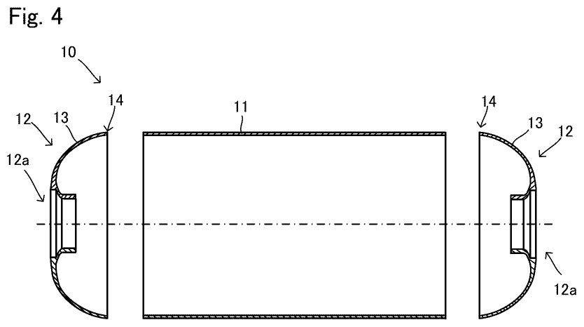

The liner 10 is described in detail below in FIG. 3. FIG. 3 is a view showing the liner 10 from the same viewpoint as in FIG. 2. Further, the liner 10 in FIG. 4 is represented by separating the cylindrical portion 11 and the dome portion 12. Liner 10 is a cylindrical portion 11 and the dome portion 12 is prepared separately, the dome portion 12 so as to cover the respective openings of the end portion of the cylindrical portion 11 is joined over the entire circumference of the cylindrical portion 11 (laser welding) (dotted line W in FIG. 3 is the joint site). Therefore, the portion to be joined with the cylindrical portion 11 to the dome portion 12 side in this embodiment, and a joint portion of each form to be described later.

### 2.1. Form 1

### 2.1.1. Cylindrical Portion

The cylindrical portion 11 is a main portion of the liner 10 for storing hydrogen therein, and is a cylindrical member having a generally constant diameter.

The material constituting the cylindrical portion 11 is not particularly limited as long as it is a material capable of bonding with the dome portion 12 by laser welding, but examples thereof include a material in which a polyamide resin is laminated on each of both surfaces of an ethylene vinyl alcohol copolymer resin and is made of 3 layers.

Although the thickness of the cylindrical portion 11 is not particularly limited, a 0.5 mm to 3.0 mm is typical.

Such cylindrical portion 11 can be made, for example, by extrusion.

### 2.1.2. Dome Portion

Dome portion 12 is disposed at each of the open ends of the cylindrical portion 11 is a member which is joined over the entire circumference of the cylindrical portion 11 is disposed so as to cover the opening. The opposite side of the domed portion 12 to the side joined to the cylindrical portion 11 is narrowed diameter, the opening 12a is formed in the narrowed end. A mouthpiece 3 is disposed in this opening 12a

Here, the material constituting the dome portion 12 is not particularly limited as long as it is a material capable of bonding with the cylindrical portion 11 by laser welding, but may be formed of, for example, a polyamide resin, and may be manufactured by injection molding.

As described above, the dome portion 12 includes a joint portion 14 which is a portion to be joined to the cylindrical portion 11 In other words, the dome portion 12 has a body 13 which is a main portion of the dome portion 12 (a portion forming a portion other than the joint portion 14), and a joint portion 14 which is disposed at an end portion of the body 13 on the side of the cylindrical portion 11

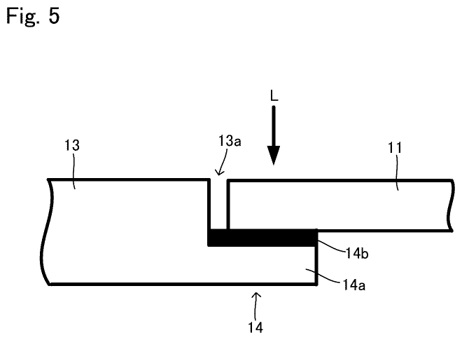

5, at the site indicated by I in FIG. 3, it represented an enlarged view of the end of the body 13 and the joint 14 which is continuous with this. Although each of the figures shown in FIG. 5 and below is a cross-section, hatching is omitted for ease of viewing.

In this form, the joint portion 14 has a base portion 14a and a deep (dark) color portion 14b

The base 14a is a portion provided in an annular shape along an end surface of the body 13, and is integrally formed continuously with the body 13 Thus, the base 14a is made of the same material as the body 13.

In this form, the base 14a has an inner diameter that is flush with the body 13 without a step, the outer diameter is smaller than the body 13. Thus, the body 13 and the step 13a is formed. In some embodiments, the outer diameter of the base portion 14a is not particularly limited, but is about the same or slightly smaller than the inner diameter of the cylindrical portion 11. In some embodiments, the depth of the step 13a is not particularly limited, but is about the same level as the thickness of the cylindrical portion 11. Thus when fitting the cylindrical portion 11 in the stepped 13a, and the outer diameter of the outer diameter and the cylindrical portion 11 of the main body 13 is substantially flush.

Deep color portion 14b is a dark layers provided along the outer peripheral surface of the base 14a. The meaning of “deep in color” is explained later.

The thickness of the deep color portion 14b is not particularly limited, but may be a thickness capable of absorbing laser energy to generate heat and appropriately weld, and is typically 10 μm or more and 100 μm or less.

Think about the darker color in the deep color portion 14b as follows.

The base 14a is configured to have a higher transmittance (translucency) than the deep color portion 14b when the base 14a is compared with the deep color portion 14b. Transmittance of light can be achieved, for example, by comparing total light transmittance. This is the ratio of the amount of light passing through the object when the amount of light passing through the space when there is no object is taken as 100%.

According to this, the light is easily transmitted with respect to the base 14a, since it can be visually foreign matter inspection in the liner, can be omitted or reduced such expensive devices and destructive inspection such as X-rays.

In addition, since it is possible to perform the inspection in a non-destructive manner, it becomes possible to inspect all of the products. In the inspection, since the light permeability is good, further inspection is facilitated by transmitting light using a light source.

On the other hand, the cylindrical portion 11, the inner peripheral surface at its end portion is fitted so as to overlap the outer peripheral surface of the joint portion 14 of the dome portion 12 (i.e. deep color portion 14b). The lasers are irradiated to the deep color portion 14b from the outside as indicated by an arrow L in FIG. 5. At this time, since the light is hardly transmitted with respect to the deep color portion 14b, the laser energy is easily absorbed by the deep color portion 14b when the deep color portion 14b is irradiated with the laser light, and the surrounding resin is melted by heat generation, so that the fusion is efficiently performed.

Thus, according to the present embodiment, it is possible to achieve both ease of inspection and good welding quality.

However, in order to make this effect more remarkable, in some embodiments, the base 14a is a color of a pale color such as a transparent or milky white (a color having a lower lightness, for example, 7 or more of 0 to 10 in a Munsell color system). Transparent means the degree to which, in the nature of a substance through which light passes, the transmittance of light is high and what is present beyond it through the substance is visible through it. According to this, it is possible to enhance ease of visual inspection. If it is not transparent, it is possible to further facilitate visual inspection by applying light from the back side.

On the other hand, since the deep color portion 14b makes the effect more remarkable, in some embodiments, the color is a color having a lower lightness, and, in some embodiments, the color is a black color. For example, it can be 5 or less of 0 to 10 in the Munsell color system.

As a specific deep color portion 14b, for example, a material obtained by adding a black pigment such as carbon black to a resin (polyamide resin or the like) can be formed by coating the base 14a.

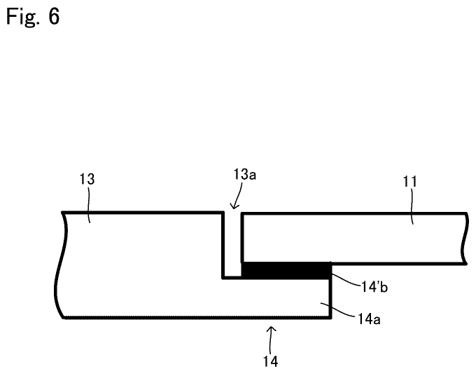

FIG. 6 showed the figure which explains the modification of the above-mentioned Form 1. FIG. 6 is a view from the same viewpoint as in FIG. 5. In this case, a deep color portion 14′b is used instead of the above-described deep color portion 14b.

Since other parts can be considered in the same manner as described above, the same reference numerals will be used and description thereof will be omitted.

Deep color portion 14′b is obtained by arranging an annular member having a thin thickness so as to wind around the outer periphery of the base 14a. The color of the annular member constituting the deep color portion 14′b can be considered in the same manner as the above-described deep color portion 14b.

In the annular member, for example, a band-shaped material in which a black pigment such as carbon black is added to a resin (polyamide resin or the like) is molded, and this material may be wound around the base 14a.

When such a deep color portion 14′b is provided, the same aspects as described above can be obtained.

### 2.2. Form 2

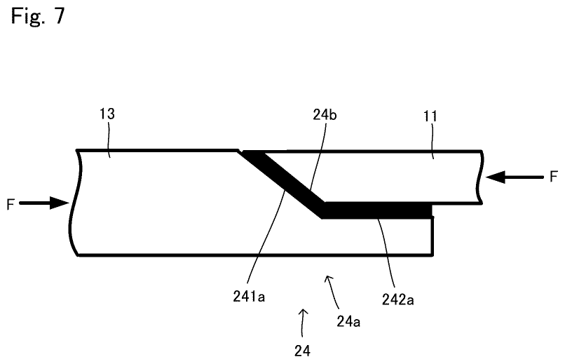

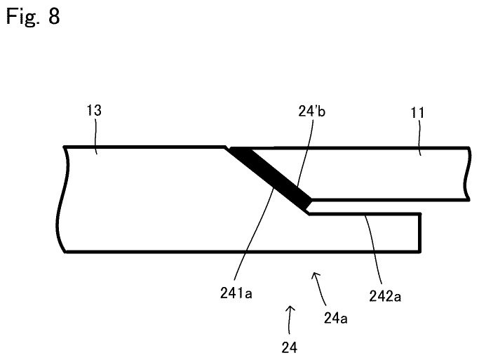

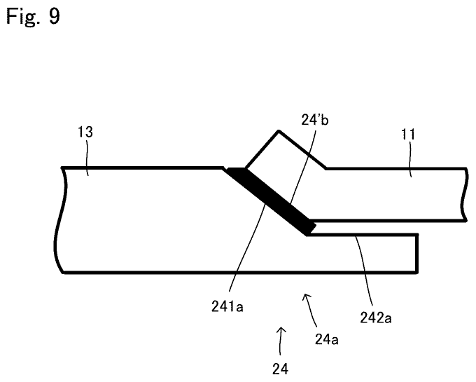

FIG. 7 to FIG. 9 showed the figure which describes about the form 2. FIGS. 7 through 9 are views according to the same viewpoint as FIG. 5, and FIG. 8 is one modification to FIG. 7 and FIG. 9 is another modification to FIG. 8.

In Form 2, the shape of the joint portion is different from that of Form 1, but the other portions can be considered in the same manner as in Form 1, and therefore, description thereof will be omitted here. The joints will be described below.

As shown in FIG. 7, the joint 24 in the present embodiment has a base 24a and a deep color portion 24b.

The base 24a is a portion provided in an annular shape along an end surface of the body 13, and is integrally formed continuously with the body 13. Thus, the base 24a is made of the same material as the body 13.

In this form, the base 24a has a first annular portion 241a disposed at a position to be a body 13 side, and a second annular portion 242a disposed on a side opposite to the body 13 side of the first annular portion 241a.

Both of the first annular portion 241a and the second annular portion 242a, the inner diameter is flush without step with the body 13.

On the other hand the first annular portion 241a for the outer diameter is the same outer diameter as the main body 13 in the main body 13 side, has an inclined surface so that the outer diameter decreases toward the second annular portion 242a. And the second annular portion 242a of the first annular portion 241a is the same as the outer diameter of the second annular portion 242a. In some embodiments, the inclination angle of the inclined surface is 15 degrees or more and 75 degrees or less with respect to the axis O. In some embodiments, the inclination angle of the inclined surface is 30 degrees or more and 60 degrees or less. If the inclination angle is greater than 75 degrees, the force required when fitting the cylindrical portion 11 and the dome portion 12 tends to be too large. On the other hand, when the inclination angle is less than 15 degrees, the length for press-fitting during the fitting tends to increase the extension and material amount of processing time becomes longer.

On the other hand, the outer diameter of the second annular portion 242a is not particularly limited, in some embodiments, the inner diameter of the cylindrical portion 11 is the same or slightly smaller than the inner diameter. Then, the difference between the outer diameter of the second annular portion 242a and the outer diameter of the body 13 is not particularly limited, in some embodiments, is the same level as the wall thickness of the cylindrical portion 11. Thus when fitting the cylindrical portion 11 to the joint portion 24, and the outer diameter of the outer diameter and the cylindrical portion 11 of the main body 13 is substantially flush.

Deep color portion 24b in the present embodiment is a dark layers provided along the outer peripheral surface of the base 24a. Embodiments of the deep color portion 24b and the effectiveness thereof can be considered in the same manner as the above-described deep color portion 14b.

According to such a joint portion 24, in addition to the effects described in the 1 form described above, the fitting of the cylindrical portion 11 and the dome portion 12 can be firmly performed. For example, in the absence of the first annular portion, the form as in FIG. 5 described in Form 1, in the entrance corner of the step 13a, to form an arc-shaped portion to prevent stress concentration (R-shaped). The gap is formed on the opposite end surface of the body 13 and the cylindrical portion 11 as shown in FIG. 5 from the fact that there is an R shape.

In contrast, according to Form 2, since the cylindrical portion 11 and the dome portion 12 can be fitted together without this gap, it is possible to improve the strength at the time of deformation and to prevent the impregnation resin of the reinforcing layer 2 from entering. Further, since it is possible to apply a load in a direction along the axis O as indicated by the arrow F at the time of bonding, it is easy to control the surface pressure at the time of welding the inclined surface, it is possible to attempt to stabilize the welding quality. Further, since the liner is thinner in the portion when there is a gap, it is also possible to reduce the amount of hydrogen permeation by eliminating the gap.

The example shown in FIG. 8 is a modification of the example shown in FIG. 7, an example in which the deep color portion 24′b is disposed only in the first annular portion 241a. In some embodiments, both the first annular portion 241a and the second annular portion 242a as shown in FIG. 7 from the viewpoint of bonding strength is bonded are arranged deep color portion 24b, in this way only the first annular portion 241a from the viewpoint of productivity if it is possible to sufficiently secure the strength it may be provided a deep color portion 24′b.

The example shown in FIG. 9 is a modification of the example shown in FIG. 8. In the example shown in FIG. 9 is an example in which the end portion of the cylindrical portion 11 along the slope of the first annular-portion 241a is not made. Even in such a form, the above-described effect can be achieved. According to this example, it is possible to reduce the process because it does not require the end processing of the cylindrical portion 11.

### Reference Signs List

1 . . . Hydrogen-tank, 2 . . . reinforcement layer, 3 . . . mouthpiece, 4 . . . valve on-off, 10 . . . liner, 11 . . . cylinder, 12 . . . dome, 13 . . . body, 14, 24 . . . junction, 14a, 24a . . . base, 14b, 24b . . . deep color portion, 241a . . . first annulus, 242a . . . second annulus

What is claimed is:

1. A hydrogen tank comprising:
a liner including a cylindrical portion and dome portions, the dome portions being disposed at both ends of the cylindrical portion, respectively, the dome portions each having a body and a joint portion, the joint portion being joined to the cylindrical portion, wherein
the joint portion includes a deep color portion, and the body has a translucency higher than the joint portion.

2. The hydrogen tank according to claim 1, wherein
a thin film portion is provided along a circumference of the joint portion, the thin film portion being the deep color portion extending annularly, and
the thin film portion is in contact with and joined to the cylindrical portion.

3. The hydrogen tank according to claim 1, the joint portion further comprising:
a first annular portion; and
a second annular portion provided closer to the cylindrical portion than the first annular portion is, the second annular portion having an outer diameter smaller than that of the first annular portion, wherein
the first annular portion is provided with an inclined portion in which a diameter of the first annular portion at a closer position to the second annular portion is smaller, and
the cylindrical portion and the dome portions are joined at least at the inclined portions of the first annular portions.
